(19) United States
(12) Patent Application Publication
(10) Pub. No.: US 2019/0344886 A1
(43) Pub. Date: Nov. 14, 2019

(54) SYSTEM AND METHOD FOR AUTONOMOUSLY MONITORING LIGHT POLES USING AN UNMANNED AERIAL VEHICLE

(71) Applicant: Vardhan Kishore Agrawal, Cupertino, CA (US)

(72) Inventor: Vardhan Kishore Agrawal, Cupertino, CA (US)

(73) Assignee: Vardhan Kishore Agrawal, Cupertino, CA (US)

(21) Appl. No.: 16/403,531

(22) Filed: Jun. 29, 2019

Related U.S. Application Data
(60) Provisional application No. 62/669,364, filed on May 9, 2018.

(51) Int. Cl. B64C 39/02; G08G 1/01; H02G 1/02

(52) U.S. Cl. CPC B64C 39/02; G08G 1/012; B64C 2201/12; B64C 2201/141; H02G 1/02

(57) ABSTRACT

An autonomous aerial solution is disclosed to monitor the status of light pole bulbs and report its findings to the operator. The system involves the use of a smartphone and a consumer UAV to give users the ability to autonomously monitor light poles. The invention consists of three main parts: (i) autonomous path planning and flight, (ii) training a custom convolutional neural network, and (iii) classifying RGB light pole images. While following FAA regulations, the UAV avoids most obstacles. As the UAV approaches a light pole, it (i) slows down, (ii) centers itself, (iii) captures an image, and (iv) heads towards the next pole. Upon completion, the UAV returns to its takeoff position, and the program analyzes the images using a trained convolutional neural network. As the UAV descends, the data is available to the operator using an intuitive color-coded map.

### FIELD OF THE INVENTION

The present invention relates to UAVs. More specifically, it relates to autonomously monitoring light poles using UAV technologies.

### BACKGROUND

Light poles ensure that our neighborhoods are well lit and safe. There are many things which can cause light poles to malfunction, some of which include: (i) malfunctioning photovoltaic sensors; (ii) collision with a vehicle; (iii) vandalism or simply the light bulb having gone out. In addition to the risk of increased crime, areas left in the dark would not be favorable to other technology such as camera-based computer vision surveillance or license plate readers. The inspection industry continues to make advances in monitoring technology to solve these issues, particularly with regards to China and their use of UAVs. Chinese Patent No. 108230678A teaches of a UAV system for monitoring traffic and roadways but does not include street lamp maintenance. Chinese Patent No. 108255196A discloses a street light inspection system using UAVs that communicate with each pole but do not utilize image recognition. Chinese Patent No. 207937847U and 108400554A teach of electric tower UAV monitoring systems; however, they are not specifically designed for street lamps.

The purpose of this invention is to monitor the “on” or “off” status of a cluster of light poles in a selected geographic area in an accurate and efficient manner using an unmanned aerial vehicle, which will be referred to as the “UAV.” When combined with the present invention, the solution, as a whole, can be referred to as an unmanned aerial system, which will be referred to as the “UAS.”

This invention involves the use of a smartphone and a consumer UAV to provide government agencies the ability to autonomously monitor light poles.

### BRIEF SUMMARY OF THE INVENTION

This invention involves the use of a smartphone and a consumer UAV to give government agencies the ability to autonomously monitor light poles and optimizing the task. A report of the data can be exported in a variety of different file formats. Residents can report outages via companion software or within a different mode of the present software.

The invention is a smartphone application which remotely pilots a UAV and uses a machine learning model (e.g. convolutional neural network) and a dataset to classify the images of light poles. The versatility of such a setup allows the UAV to fly at a safe height above trees and major obstacles while still getting accurate results (over 90%).

With the flight time of UAVs limited by modern day battery technology, it is also critical to calculate the shortest path to each of the selected poles to prevent wasting valuable flight time and monitoring the most poles in the least amount of time. For this purpose, the invention uses Dijkstra's Algorithm, which solves the Traveling Salesman Problem. With this algorithm, we are able to calculate the least-cost single-pair shortest path and use it to maximize the range of the UAV and its battery.

### DETAILED DESCRIPTION OF THE INVENTION

The invention is described in three steps: (i) autonomous flight path planning, (ii) training a neural network, and (iii) classifying light pole images. With these steps integrated, a complete autonomous light pole monitoring solution is developed.

Regardless of the variations among light poles, in their fixture or otherwise, the invention's convolutional neural network is able to recognize each light pole with an accuracy of more than 90% without any information about the pole. The only data which is requested at the time of flight from the operator is the selection of light poles via an interactive map displaying the locations of light poles.

When deployed, the following takes place: (i) the invention calculates the least cost path for the UAV before taking off; (ii) in flight, the UAV reports its location to the app for operator monitoring; (iii) when the aircraft has completed visiting the selected light poles, it returns to the absolute location from which it was deployed; (iv) on the return trip, images are analyzed and presented to the operator on the map.

Images are captured at an altitude of 50 meters to ensure safety and to keep a strategic distance from obstacles. The neural network classifies the light poles into two categories: “on” and “off”. Using a color-coded user interface, this information is displayed along with the actual images, for the operator to manually verify. To obtain the most accurate reading, the UAV has to be positioned directly above the light pole. The model is trained to handle aberations in lighting conditions.

Using GPS, the downward visual positioning system, and the RGB camera, the app directs the UAV to accurately visit each individual light pole. This process is achieved in two steps: (i) the UAV arrives at a latitude-longitude coordinate which is accurate to a decillionth of a degree and treats it as a “rough” location estimation; (ii) the UAV uses bottom facing cameras and a 3D mapping system to position itself directly over the light pole.

The conventional strategy known as ‘brute force,’ is often utilized in such inspection path plans—the method includes taking each possible path and comparing it to every other possible path. This process has an element of ‘exponential time complexity’—which means that every time another light pole is added, the time needed to calculate that path doubles. This can be represented as O(2\hat{ }n). This method often proves to be an inefficient way of solving the path problem, and it can result in an unnecessary waste of processing power. Dijkstra's algorithm, however, has a ‘quadratic time complexity,’ which means that every time the number of light poles is doubled, the time it takes to calculate the route gets multiplied by four. This method is represented by O(n\hat{ }2), which makes it clearly much more efficient in solving time inefficiencies in route planning. Due to the efficiencies demonstrated in Dijkstra's algorithm, the software utilized in this drone disclosure will be utilized.

As compared to image thresholding, image binarization, canny edge detection, or a combination of these methods used in this disclosure, a convolutional neural network yields the best results and accuracy. In addition to this fact, the more data that it receives, the more accurate the results become.

The UAV is able to fly at a cruising velocity of, but not limited to 10 meters per second and at an altitude of, but not limited to 50 meters. Based on these specifications, the invention has the potential to visit at least 100 light poles in a single flight. In addition, UAV is also able to detect and avoid obstacles, and upon landing, it is able to locate its takeoff coordinates within 10 centimeters.

Since a machine learning model is being used, the accuracy, recall percentages, and time complexities in this invention are open to variation, and are able to be increased with algorithm optimizations and/or an addition of data in the dataset. With a larger, ever-growing dataset, the accuracy can drastically increase in future revisions of this invention.

The UAV is able to take readings from a height of 50 meters, which eliminates the need for any obstacle avoidance and reduces residential disturbance due to noise pollution. The UAV satisfies this requirement, as it remains within Federal Aviation Administration (FAA) regulations, and takes into account common-sense and civil safety considerations.

Via the software component of this invention, the data can be downloaded by the user as a file in a format including, but not limited to: (i) JavaScript Object Notation (JSON), (ii) Comma Delimited Values (CSV), (iii) Portable Document Format (PDF), or it can be exported to an external database to be stored and fetched at a later time.

Relating to the current embodiment, a resident, that is, one who is affected by the outages of light poles, but not the governing agency, can report “off” light poles or malfunctioning ones to bring to the attention of the operator. This information can be verified by autonomously appending the request to the UAVs next flight.

### DETAILED DESCRIPTION OF THE DRAWINGS

The present invention will be accompanied by drawings which will aid in the explanation and description of its current embodiment.

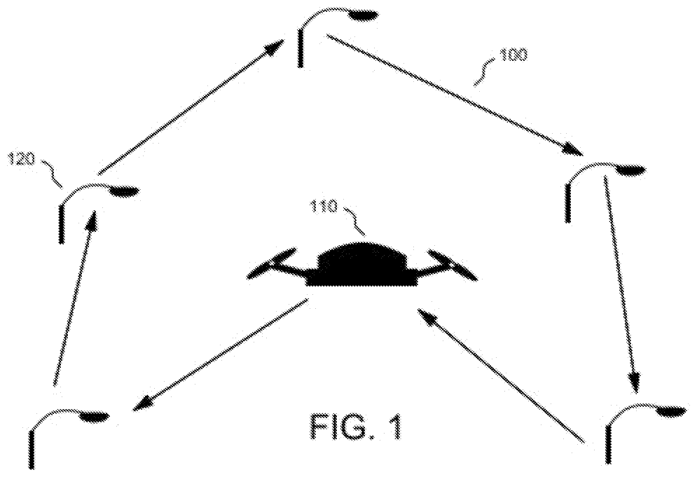

FIG. 1 is an illustration demonstrating the calculation of a least-cost path, allowing the UAS to operate at maximum efficiency. The least-cost path is shown as 100 in FIG. 1. The UAV, shown as 110, is autonomously operated, allowing the remote software to perform the current embodiments of these calculations. The nodes, or, in the case of the present embodiment of the invention, light poles, are represented as 120 in FIG. 1

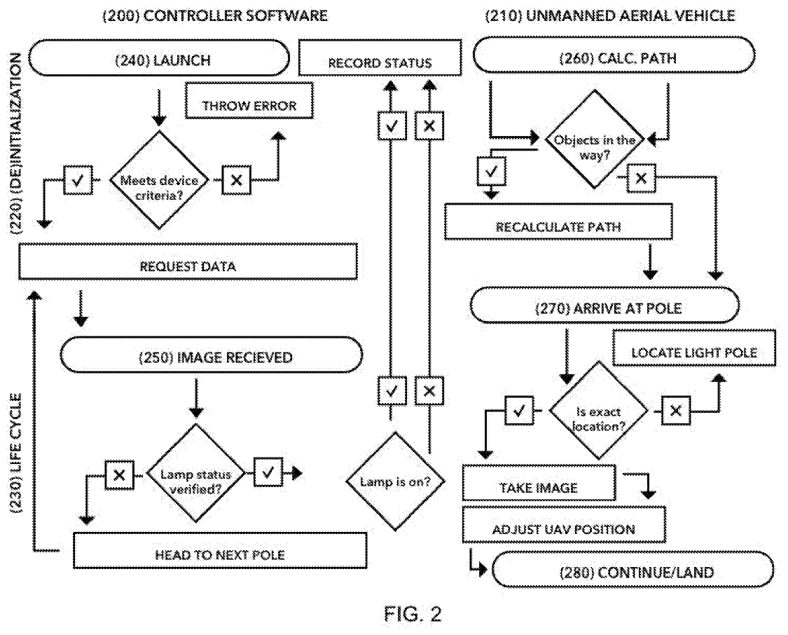

FIG. 2 represents the logical flow, that is, in this embodiment of said software, more specifically, the remote software, of the present invention. The categories in FIG. 2 are represented as “controller software” which is shown as 200, “unmanned aerial vehicle” which is shown as 210, and, the life cycle of the application, which are represented in the “de(initialization)” state as 220, and the main “life cycle” as 230. The present embodiment of the said remote software begins when it is initially launched by the end-user (represented as 240). At this stage, low-level firmware checks and device compatibility checks are performed as detailed in FIG. 2. After these checks have passed and the requested data packet, which, in the current embodiment, is the image, represented as 250, is classified as either “on” or “off”. The aforementioned steps were taken in 200, that is, the remote controller and its accompanying software. In 260, which is the calculation of the least-cost path, which, as implied in FIG. 2, lies under category 210 of the flowchart, that is, the autonomous unmanned aerial vehicle piloting steps. Whilst in flight, the UAV arrives at a node, which, in the current embodiment of the invention, is, again, a light pole, represented as 270 in FIG. 2 and performs a series of checks to ensure accurate positioning. At the end of the flight, which, in the present invention, can be signaled by, and is not limited to: (i) termination by the end user, (ii) end of the mission, or (iii) emergency landing mandated by government agency, the UAV reaches 280, when it lands at the deployment site or continues to the next node, a light pole.

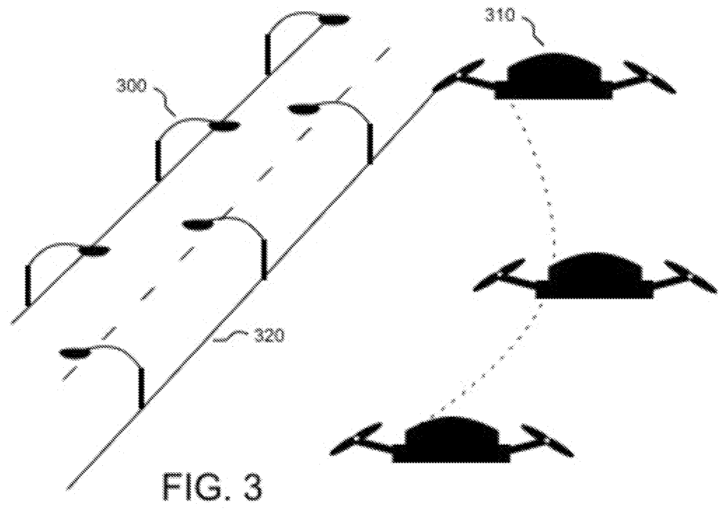

FIG. 3 represents a top-level illustration of the UAV, represented as 310, approaching a street, which is represented as 320, which contains light poles, shown in FIG. 3 as 300. Notably, light poles are referenced in the same context in which “nodes” were referenced, for example, in the description of FIG. 2.

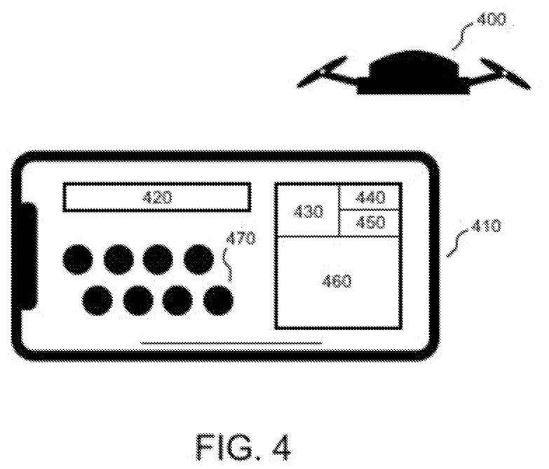

FIG. 4 is a plausible graphical user interface, which, in the current embodiment of the present invention, is being used in practice. A scrollable map, which contains visible, interactive nodes, which, in this case, are light poles are represented with 470. The UAV mission can be controlled by a universal button, 420, which is able to change based on the state of the mission. On the display cluster at right, 430 represents a plausible title display to detail information such as the type of node, which, in the current embodiment is static to “Light Pole” or the like. The status (result) and the confidence are represented in FIG. 4 as 440 and 450, respectively. The data packet is represented by 460, in this case, an image, to perform a manual observation. The smartphone, 410, and the UAV, 400, are also shown in FIG. 4.

1. A system for monitoring street lights comprised of the following parts:
a.) a UAV and;
b.) a software program;

2. The UAV of claim 1 also having onboard GPS navigation, onboard camera and onboard memory.

3. The software of claim 1 also having machine learning algorithms, path planning algorithms and 3D mapping therein.

4. A method for monitoring street lights comprising:
a.) capturing images of street lights;
b.) classifying street light status;
c.) displaying street lights on a map;
d.) planning routes for UAVs; and
e.) training neural networks.

5. The imaging of street lights of claim 4 also using machine learning to enhance accuracy of monitoring.

6. The displaying of street lights on a map of claim 4 also being displayed remotely and in real time.

7. The classifying of street light status of claim 4 also determining functionality of the lamp for replacement purposes.
